(19) United States
(12) Patent Application Publication
(10) Pub. No.: US 2019/0072753 A1
(43) Pub. Date: Mar. 7, 2019

(54) PRISM ASSEMBLIES AND OPTICAL DEVICES INCORPORATING PRISM ASSEMBLIES

(71) Applicant: Bushnell Inc., Overland Park, KS (US)

(72) Inventor: John W. Cross, Overland Park, KS (US)

(21) Appl. No.: 16/103,609

(22) Filed: Aug. 14, 2018

Related U.S. Application Data
(60) Provisional application No. 62/545,027, filed on Aug. 14, 2017.
(60) Provisional application No. 62/545,134, filed on Aug. 14, 2017.

(51) Int. Cl. G02B 23/10; F41G 1/38; G02B 27/10; F41G 1/473; F41G 3/06

(52) U.S. Cl. CPC G02B 23/10; F41G 1/38; F41G 3/06; F41G 1/473; G02B 27/10

(57) ABSTRACT

An optical device for viewing a scene or subject while, at the same time, digitally recording images corresponding to the scene or subject being viewed. The optical device includes a housing supporting an eyepiece, an objective optic, and a prism assembly. The prism assembly is located along an optical path between the objective optic and the eyepiece. The prism assembly comprises a first prism and a second prism. The prism assembly allows the user to digitally record images corresponding to a scene or subject being viewed by the user. Both still images and video images may be digitally recorded. The prism assembly inverts the light traveling along the optical path so that the orientation of the image being viewed is consistent with the actual orientation of the scene or subject. The prism assembly allows the optical device to be shorter and more compact for a given magnitude of magnification.

### RELATED APPLICATIONS

The present application claims the benefit of U.S. Provisional Application No. 62/545,027 filed Aug. 14, 2017, and the benefit of U.S. Provisional Application No. 62/545,134 filed Aug. 14, 2017, both of which are incorporated herein in their entireties by reference.

### FIELD OF THE INVENTION

The present invention is generally directed to optical devices. More specifically, the present invention is directed to optical devices with prism systems having beam splitting properties for capturing digital images.

### BACKGROUND OF THE DISCLOSURE

Optical devices, such as telescopes, binoculars, spotting scopes, rifle scopes and so on, allow users to see distant objects more clearly than with the naked eye. These devices can be used for viewing a wide variety of objects including wild animals, sporting events, and distant galaxies. When a user sees something exceptional, there is a natural desire to record what he or she is seeing. Accordingly, some known optical devices allow users to digitally record or display images corresponding to the scene or subject being viewed.

Such known optical devices typically use a discrete beam splitter system inserted between the objective lens of the optical device and its inverting prism pair. The beam splitter, which often includes a partially transparent piece of glass that can both reflect light and pass light, directs a portion of incoming light to the prisms and eyepiece for viewing by a user, and directs another portion of the incoming light to an imaging sensor. Such a device is described in U.S. Pat. No. 5,963,369, to Steinthal et al., entitled “Digital Solid-State Binoculars,” and in U.S. Pat. No. 6,487,012 to Khoshnevis et al., entitled “Optically Multiplexed Hand-Held Digital Binocular System,” both of which are incorporated herein by reference in their entireties.

However, commercially-available beam splitters tend to be relatively large and take up valuable space within the optical device. Therefore, the addition of a discrete beam splitter to an optical device, such as binoculars, tends to make the optical device relatively large as compared to optical devices not including digital recording capability utilizing typical beam splitters, such that the device can be relatively cumbersome to handle, store and transport.

### SUMMARY

The invention described in this document provides a compact optical device for viewing a scene or subject and, at the same time, digitally recording images corresponding to the scene or subject being viewed. The optical device is designed to add a beam splitting function to prism assemblies like those used in binoculars, spotting scopes, telescopes, riflescopes and so on, thus avoiding the need for a discrete beam splitter. The optical device includes a housing supporting an eyepiece with an eyepiece optic (lens or lenses), an objective optic, and a prism assembly. The prism assembly is located along an optical path between the objective optic and the eyepiece. The prism assembly comprises a first prism and a second prism. The prism assembly performs at least two functions. The first is the traditional function of inverting the light comprising the image received from the objective optics, and the second is splitting the received light to direct a portion of the received light to the eyepiece optic for image viewing and to direct a portion of the received light to an image capture device for capture or display. As such, the prism assembly allows the user to digitally record or display images corresponding to a scene or subject being viewed by the user. Both still images and video images may be digitally recorded. By accomplishing a beam-splitting function using the prism assembly required for inversion, the prism assembly allows the optical device to be shorter and more compact for a given magnitude of magnification, by avoiding a discrete and separate beam splitting system.

As described further below, embodiments of the invention include compact optical devices with beam-splitting prism assemblies that include various types of prisms, such as, Porro prism and roof prisms. In an embodiment, a compact optical device includes a beam-splitting prism assembly that includes a pair of Porro prisms and a partially-reflective plate. In another embodiment, a compact optical device includes a beam-splitting prism-assembly that includes a pair of prisms, one prism being a half-penta prism and another prism being Schmidt roof prism.

In embodiments, an optical system is designed to take advantage of a phenomenon known as frustrated total internal reflection (FTIR) in a way no prior art device has. The inventive systems may be incorporated into an optical device for viewing a scene or subject while, at the same time, digitally recording images corresponding to the scene or subject being viewed. The optical device may include a housing supporting an eyepiece optic, an objective optic, and a beam-splitting prism assembly. The prism assembly may be located along an optical path between the objective optic and the eyepiece. The prism assembly may comprise, by way of example and not limitation, two Porro prisms. The prism assembly may also include a partially-reflective plate positioned very near one face of one of the Porro prisms.

In embodiments, an optical device for viewing a scene or subject and digitally recording images corresponding to the scene or subject being viewed comprises a housing supporting an eyepiece optic, an objective optic, and a beam-splitting prism assembly located along an optical path between the eyepiece and the objective optic. In embodiments, the prism assembly comprises a first Porro prism and a second Porro prism. The first Porro prism may comprise a prism body having a first base, a second base, and a plurality of faces extending between the first base and the second base. The plurality of faces of the first Porro prism may include an entrance face, a first side face, and a second side face. The second Porro prism may comprise a prism body having a first base, a second base, and a plurality of faces extending between the first base and the second base. The plurality of faces of the second Porro prism may include a third side face, a fourth side face, and an exit face.

In embodiments, a plate is positioned near a selected face of the prism assembly. The plate may comprise a plate body and a partially-reflective coating disposed on one face of the plate body. In embodiments, a gap is defined between the partially-reflective coating and the selected face of the prism assembly. The selected face may be one of the first side face, the second side face, the third side face and the forth side face. In embodiments, an image sensor is supported by the housing at a location near the plate with the plate positioned between the image sensor and the selected face of the prism assembly. In embodiments, a sensor optical system is positioned between the plate and the image sensor. The sensor optical system may receive light transmitted through the plate and form an image on a sensing portion of the image sensor.

In embodiments, an optical device for viewing a scene or subject and digitally recording images corresponding to the scene or subject being viewed comprises a housing supporting an eyepiece with an eyepiece optic, an objective optic, and a prism assembly located along an optical path between the eyepiece and the objective optic. In embodiments, the prism assembly comprises a first prism and a second prism. In embodiments, the first prism comprises a half-penta prism and the second prism comprises Schmidt roof prism. In embodiments, the prism assembly comprises a Schmidt-Pechan prism.

In embodiments, the half-penta prism comprises a prism body, the prism body comprising a first base, a second base, and a plurality of faces extending between the first base and the second base, the plurality of faces comprising an entrance face, an exit face, and the intermediate face. In embodiments, the prism assembly further comprises a partially-reflective layer disposed on the intermediate face of the half-penta prism.

In embodiments, the exit face of the half-penta prism extends between the entrance face and the intermediate face of the half-penta prism. In embodiments, the entrance face of the half-penta prism extends between the exit face and the intermediate face of the half-penta prism. In embodiments, the intermediate face of the half-penta prism extends between the entrance face and the exit face of the half-penta prism. In embodiments, the eyepiece comprises at least one eyepiece lens and the objective optic comprises at least one objective lens.

In embodiments, the half-penta prism is positioned such that the light travelling along the optical path passes through the entrance face and into the prism body. In embodiments, the half-penta prism is configured such that light travelling along the optical path is reflected off of the exit face after passing through the input face and is configured such that the light travelling along the optical path reaches the intermediate face after being reflected off of the exit face. In embodiments, the partially-reflective layer is configured such that a first light portion of the light traveling along the optical path is transmitted through the partially-reflective layer and a second light portion of the light traveling along the optical path is reflected by the partially-reflective layer. In embodiments, the half-penta prism is configured such that the second light portion travels through the exit face after being reflected by the partially-reflective layer.

In embodiments, the device further comprises an image sensor and a sensor optical system. In embodiments, the image sensor is supported by the housing at a location proximate the intermediate face of the half-penta prism with the partially-reflective layer disposed between the image sensor and the intermediate face of the half-penta prism. In embodiments, the sensor optical system is configured to receive the first light portion and form an image on a sensor portion of the image sensor. In embodiments, the sensor optical system is disposed between the partially-reflective layer and the image sensor.

In embodiments, the Schmidt roof prism comprises a prism body, the prism body comprising a first base, a second base, and a plurality of faces extending between the first base and the second base. In embodiments, the plurality of faces comprises an input face and an output face. In embodiments, the Schmidt roof prism further comprises a first facet and a second facet that meet at an apex. In embodiments, the first facet extends in a first direction between the first base and the apex, and the first facet extends in a second direction between the input face and the output face. In embodiments, the second facet extends in a first direction between the second base and the apex and the second facet extends in a second direction between the input face and the output face.

In embodiments, the half-penta prism and the Schmidt roof prism are positioned so that the second light portion travels through the input face of the Schmidt roof prisms after traveling through the exit face of the half-penta prism. In embodiments, the Schmidt roof prism is configured so that the second light portion is reflected off of the output face of the Schmidt roof prism after the second light portion travels through the input face of the Schmidt roof prism. In embodiments, the Schmidt roof prism is configured so that the second light portion is reflected off of the first facet of the Schmidt roof prism after the second light portion is reflected off of the output face of the Schmidt roof prism. In embodiments, the Schmidt roof prism is configured so that the second light portion is reflected off of the second face of the Schmidt roof prism after the second light portion is reflected off of the first facet of the Schmidt roof prism. In embodiments, the Schmidt roof prism is configured so that the second light portion is reflected off of the input face of the Schmidt roof prism after the second light portion is reflected off of the second facet of the Schmidt roof prism. In embodiments, the Schmidt roof prism is configured such that the second light portion travels through the output face of the Schmidt roof prism after being reflected off of the input face of the Schmidt roof prism.

A feature and benefit of one or more embodiments is a compact optical device including a beam-splitting prism assembly that allows the user to digitally record images corresponding to a scene or subject being viewed by the user. Both still images and video images may be digitally recorded.

A feature and benefit of one or more embodiments is an optical device including a prism assembly that not only inverts the light traveling along the optical path so that the orientation of the image being viewed is consistent with the actual orientation of the scene or subject, but also directs a portion of the light toward an eyepiece for viewing and directs a portion of the light toward an image capture system for recordation or display—without the need for a separate discrete beam splitting system, as is typically used in the art.

A feature and benefit of one or more embodiments is an optical device including a beam-splitting prism assembly that allows the optical device to be shorter and more compact for a given magnitude of magnification.

The above summary is not intended to describe each illustrated embodiment or every implementation of the present disclosure.

### BRIEF DESCRIPTION OF THE FIGURES

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a diagrammatic plan view showing an optical device for viewing a scene or subject and digitally recording images corresponding to the scene or subject being viewed.

FIG. 2 is an enlarged diagrammatic plan view further illustrating a portion of the optical device shown in FIG. 1.

FIG. 3A through FIG. 3F are elevation and plan views showing six sides of a prism assembly.

FIG. 4 is a perspective view showing a prism assembly in accordance with the detailed description.

FIG. 5A through FIG. 5C are three views of showing a prism assembly.

FIG. 6A is a view illustrating a first prism and a partially-reflective layer 118 disposed on one face of the first prism.

FIG. 6B is an enlarged section view further illustrating the partially-reflective layer shown in FIG. 6A.

FIG. 7A is a stylized plan view showing an optical device for viewing a scene or subject and digitally recording images corresponding to the scene or subject being viewed. Optical devices in accordance with the detailed description may include, by way of example and not limitation, binoculars, monoculars, spotting scopes, and the like.

FIG. 7B is a cross-sectional view further illustrating the optical device shown in FIG. 7A. For purposes of illustration, the optical device has been sectioned along section line B-B shown in FIG. 7A.

FIG. 8A and FIG. 8B are enlarged plan views further illustrating further illustrating prism assemblies of the optical device shown in FIG. 7.

FIG. 9 is a diagrammatic plan view showing an example prism assembly.

FIG. 10 is a diagrammatic plan view showing an example prism assembly.

FIG. 11 is a diagrammatic plan view showing an example prism assembly.

FIG. 12 is a diagrammatic plan view showing an example prism assembly.

FIG. 13A is an elevation view illustrating a plate. The plate of FIG. 13A comprises a plate body and a partially-reflective layer overlaying one face of the plate body. FIG. 13B is an enlarged section view further illustrating the partially-reflective layer shown in FIG. 13A.

FIG. 14A through FIG. 14F are elevation and plan views showing six sides of a prism assembly.

While embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

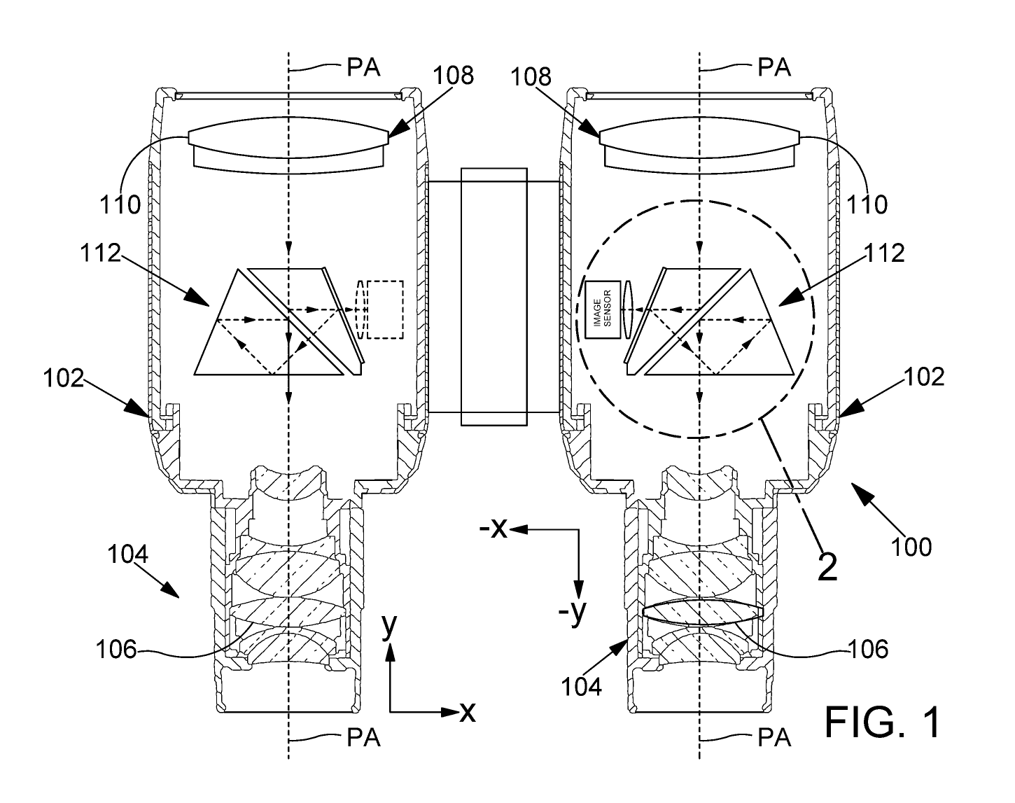

FIG. 1 is a diagrammatic plan view showing an optical device 100 for viewing a scene or subject and digitally recording images corresponding to the scene or subject being viewed. In the example embodiment of FIG. 1, the optical device 100 comprises a pair of binoculars. Optical devices in accordance with this detailed description may include, by way of example and not limitation, binoculars, monoculars, spotting scopes, and the like. The optical device 100 of FIG. 1 comprises a housing 102 supporting an eyepiece 104, an objective optic 108 and a prism assembly 112 disposed along an optical path PA between the objective optic 108 and the eyepiece 104. In the embodiment of FIG. 1, the eyepiece 104 includes an eyepiece lens 106 and the objective optic 108 includes an objective lens 110. The optical device 100 of FIG. 1 also includes an image sensor 126 and a sensor optical system 128.

In an embodiment, optical device 100 includes two prism assemblies or sets, but only a single beam-splitting prism assembly 112 and associated image sensor 126 and sensor optical system 128, as depicted. In such an embodiment, only light from one prism assembly 112 is directed to an image sensing or image capture device. In another embodiment, optical device 100 may include two beam-splitting prism assemblies 112, such that light and images from both prism assemblies 112 can be viewed and captured digitally.

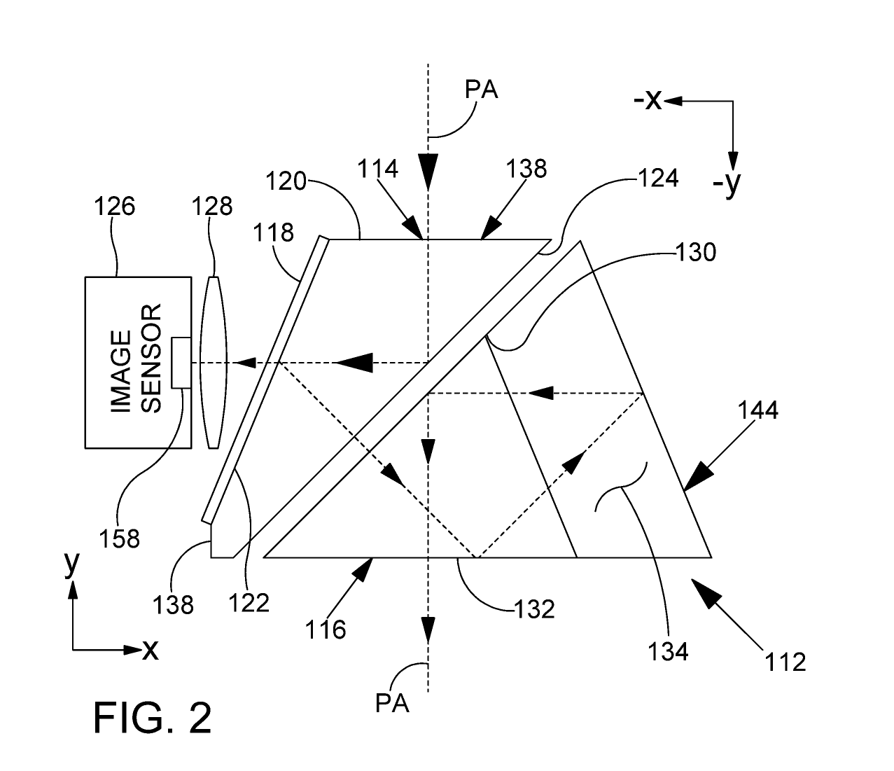

FIG. 2 is an enlarged diagrammatic plan view further illustrating the prism assembly 112 of the optical device 100 shown in FIG. 1. The prism assembly 112 of FIG. 2 includes a first prism 114 and a second prism 116. In the example embodiment of FIG. 2, the first prism 114 comprises a half-penta prism and the second prism 116 comprises a Schmidt roof prism. An image sensor 126 and a sensor optical system 128 are also visible in FIG. 2. The image sensor 126 may comprise various image sensing devices, such as a charge-coupled device (CCD), a complementary metal oxide semiconductor (CMOS) device without deviating from the spirit and scope of the detailed description. Image sensing devices, and others, that may be suitable in some applications are disclosed in the following United States patents, all of which are hereby incorporated by reference herein: U.S. Pat. No. 4,805,026, U.S. Pat. No. 4,816,916, U.S. Pat. No. 5,111,263, U.S. Pat. No. 5,506,429, U.S. Pat. No. 6,160,282, U.S. Pat. No. 6,177,293, U.S. Pat. No. 6,635,912, U.S. Pat. No. 7,153,720, U.S. Pat. No. 7,294,873, U.S. Pat. No. 9,437,644, U.S. Pat. No. 9,590,652, and U.S. Pat. No. 9,615,042. In the embodiment of FIG. 2, the image sensor 126 is located near the intermediate face 122 of the first prism 114 with the partially-reflective layer 118 disposed between the image sensor 126 and the intermediate face 122 of the first prism 114. In embodiments, the sensor optical system 128 is configured to receive the first light portion and form an image on a sensor portion 158 of the image sensor 126. In embodiments, the sensor optical system 128 is disposed between the partially-reflective layer 118 and the image sensor 126.

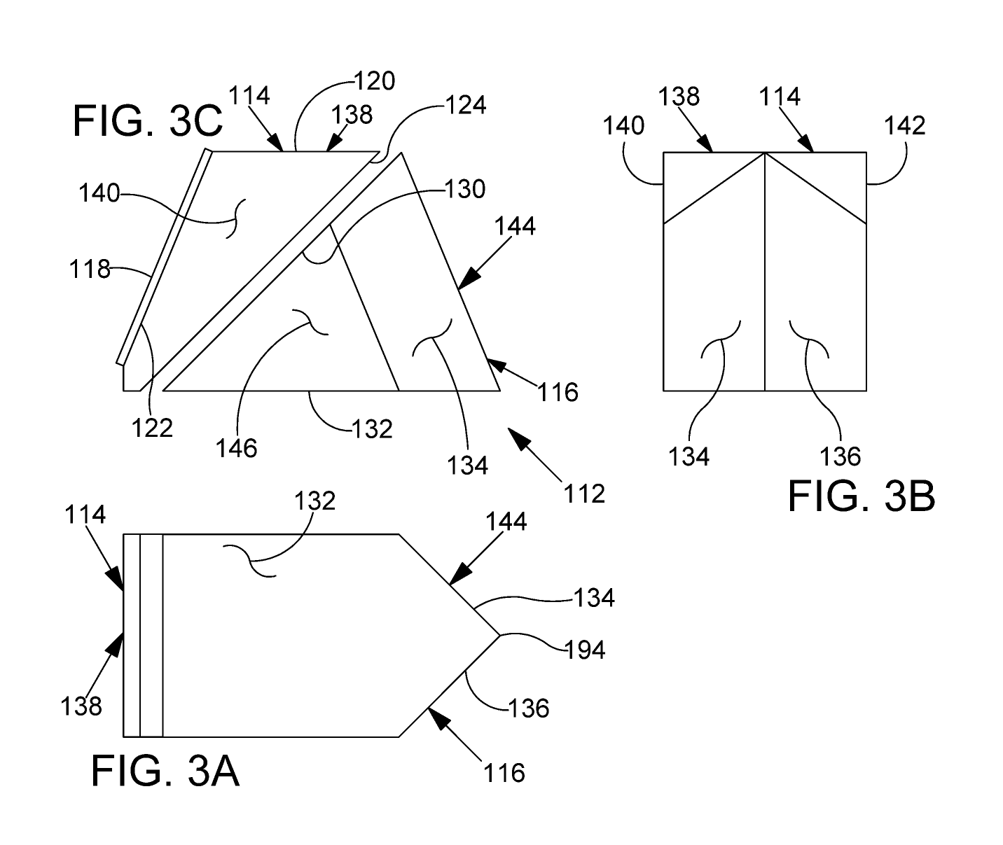

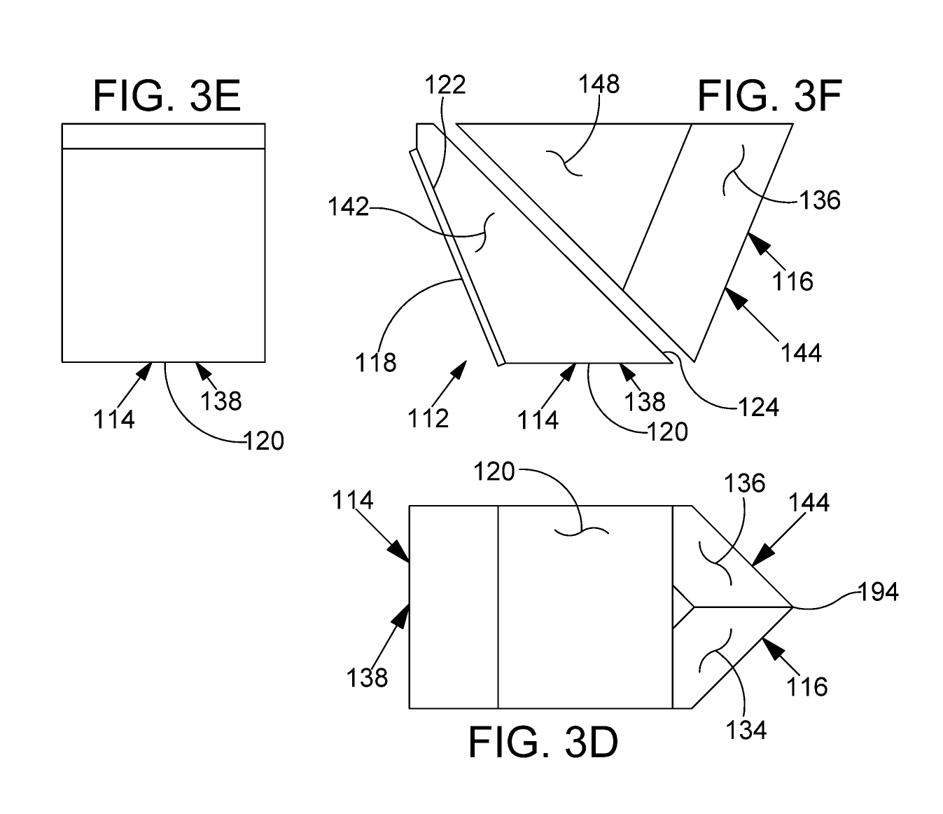

FIG. 3A through FIG. 3F are elevation and plan views showing six sides of a prism assembly 112 including a first prism 114 and a second prism 116. A person of ordinary skill in the art would generally refer to the process used to create views showing six sides of a three dimensional object as a multi-view projection or orthographic projection. It is customary to refer to multi-view projections using terms such as front view, right side view, top view, rear view, left side view, and bottom view. Accordingly, terms such as front view and right side view may be used as a convenient method for discussing the views shown in FIG. 3. It will be appreciated that the elements shown in FIG. 3 may assume various orientations without deviating from the spirit and scope of this detailed description. Accordingly, the terms front view, right side view, top view, rear view, left side view, bottom view, and the like should not be interpreted to limit the scope of the invention recited in the attached claims.

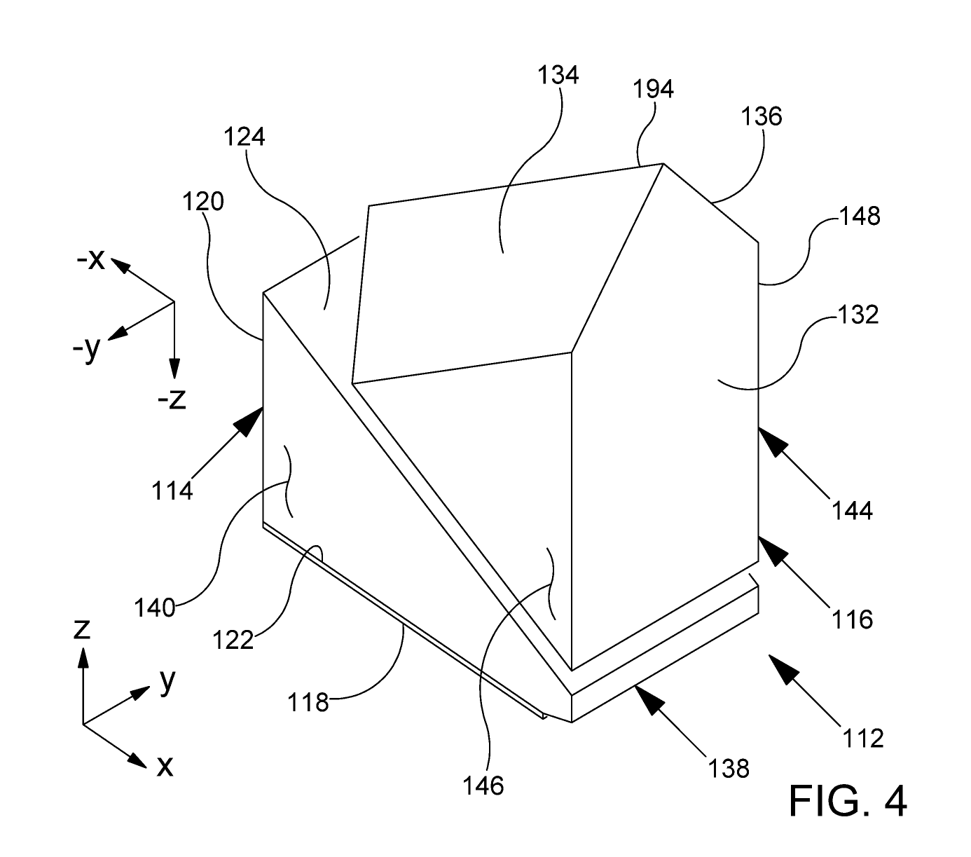

FIG. 4 is a perspective view showing a prism assembly 112 in accordance with this detailed description. The prism assembly 112 of FIG. 4 includes a first prism 114 and a second prism 116. In the example embodiment of FIG. 2, the first prism 114 comprises a half-penta prism and the second prism 116 comprises a Schmidt roof prism.

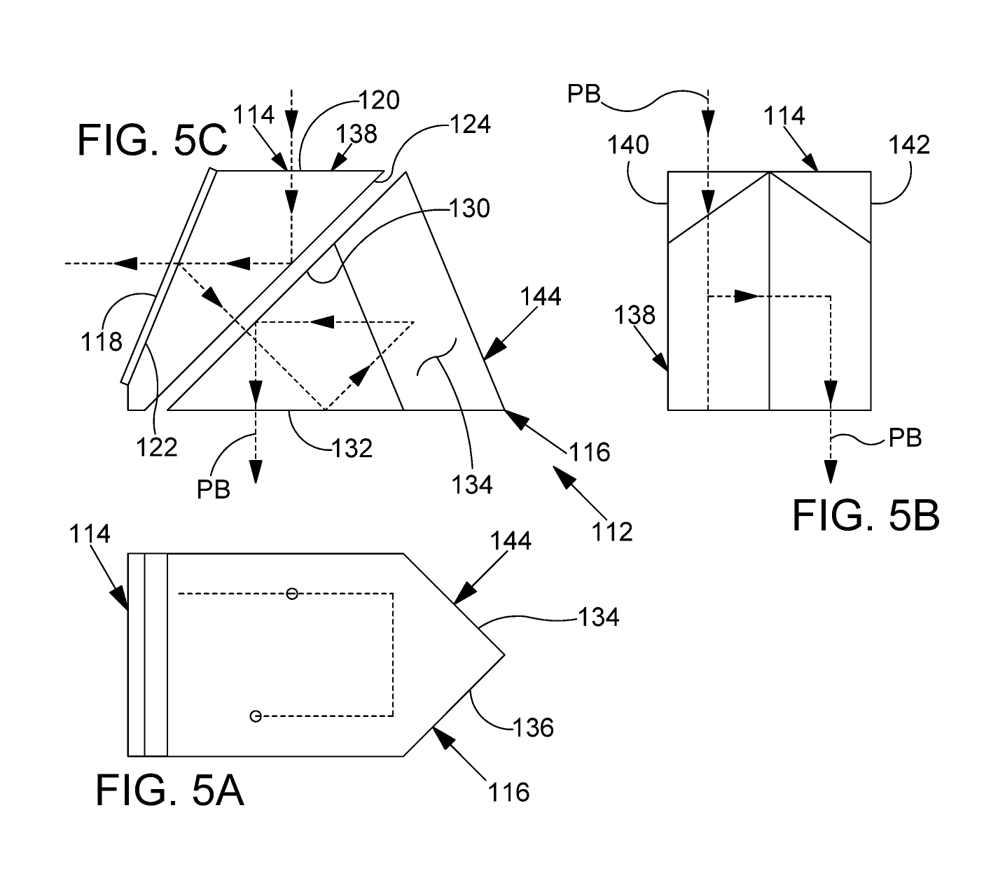

FIG. 5A through FIG. 5C are three views of showing a prism assembly 112 including a first prism 114 and a second prism 116. FIG. 5A through FIG. 5C may be collectively referred to as FIG. 5. In FIG. 5, dashed lines are used to illustrate light travelling along an optical path PB through the prism assembly 112. As shown in FIG. 5, light travelling along the optical path PB passes through the entrance face 120 of the first prism 114 and into the prism body 138 of the first prism 114. The light travelling along the optical path PB is reflected off of the exit face 124 of the first prism 114 after passing through the entrance face 120. The light travelling along the optical path PB reaches the intermediate face 122 of the first prism 114 after being reflected off of the exit face 124.

In the embodiment of FIG. 5, the prism assembly 112 includes a partially-reflective layer 118 disposed on the intermediate face 122 of the first prism 114. In embodiments, the partially-reflective layer 118 is configured such that a first light portion of the light traveling along the optical path PB is transmitted through the partially-reflective layer 118 and a second light portion of the light traveling along the optical path PB is reflected by the partially-reflective layer 118. In the embodiment of FIG. 5, the second light portion travels through the exit face 124 of the first prism 114 after being reflected by the partially-reflective layer 118.

In an embodiment, of the light traveling along the optical path PB is “split” such that the first light portion comprises substantially the same characteristics as the second light portion, such as wavelength. This contrasts with embodiments wherein the partially-reflective layer 118 acts as a filter, reflecting light having certain characteristics or wavelengths, e.g., laser light, while allowing light of other characteristics or wavelengths, ordinary visible light, to pass through the layer 118. In this manner, i.e., the first light portion and the second light portion having substantially the same characteristics, light reflected from the observed image is available both for a user to view at the eyepiece 104 and for the sensor optical system 128 to capture.

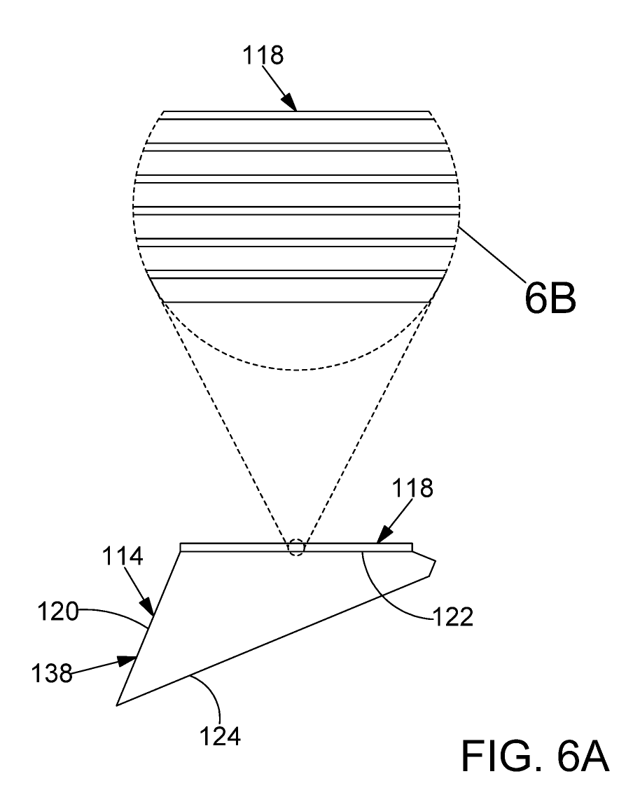

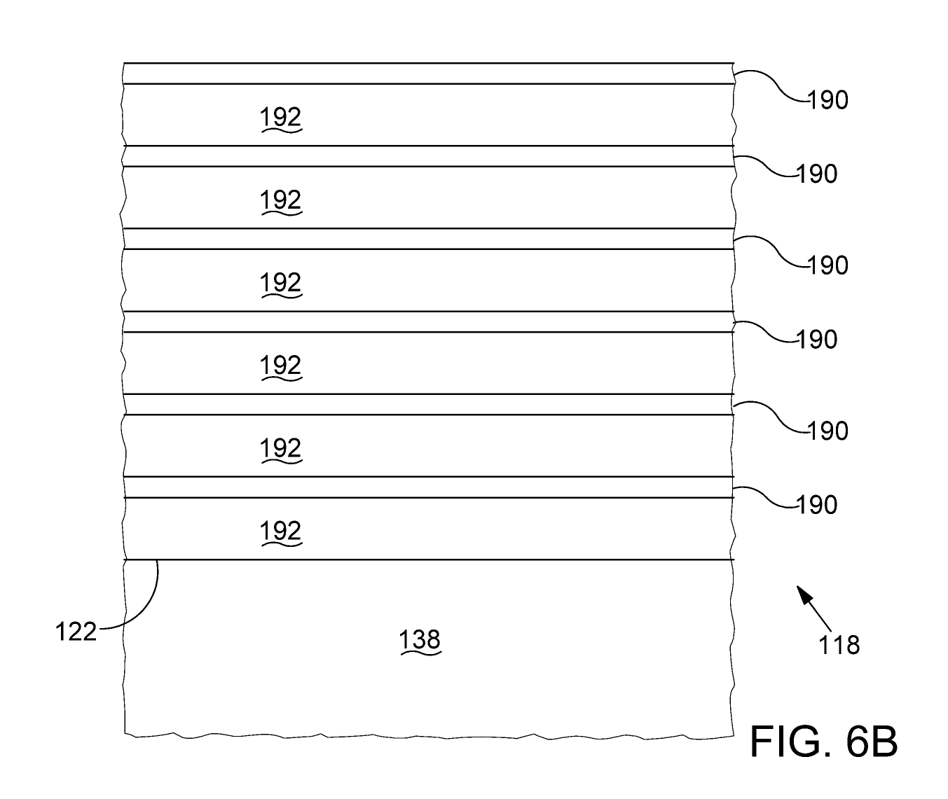

FIG. 6A is a view illustrating a first prism 114 and an embodiment of a partially-reflective layer 118. In the embodiment of FIG. 6A, the partially-reflective layer 118 is disposed on an intermediate face 122 of a prism body 138 of the first prism 114. The prism body 138 comprises a first base, a second base, and a plurality of faces extending between the first base and the second base. The faces of the prism body include an entrance face 120, an exit face 124, and the intermediate face 122.

FIG. 6B is an enlarged section view further illustrating the partially-reflective layer 118 shown in FIG. 6A. In the embodiment of FIG. 6B, the partially-reflective layer comprises a first plurality of more refractive sublayers 190 and a second plurality of less refractive sublayers 192. Also in the embodiment of FIG. 6B, the more refractive sublayers 190 and the less refractive sublayers 192 are arranged in an alternating pattern with one of the more refractive sublayers 190 overlaying each of the less refractive sublayers 192. In the embodiment of FIG. 6B, the partially-reflective layer 118 is disposed on an intermediate face 122 of a prism body 138. In some useful embodiments, each of the less refractive sublayers 192 has a first refractive index in a first range and each of the more refractive sublayers 190 has a second refractive index in a second range. In embodiments, the first range is from about 1.0 to about 1.91 and the second range is from about 1.92 to about 2.9. In embodiments, the first range is from about 1.2 to about 1.9 and the second range is from about 2.0 to about 2.8.

Each of the less refractive sublayers 192 may comprise various materials without deviating from the spirit and scope of this detailed description. Examples of materials that may be suitable in some applications include magnesium fluoride (MgF2), silicon dioxide (SiO2), and aluminum oxide (Al2O3).

Each of the more refractive sublayers 190 may comprise various materials without deviating from the spirit and scope of this detailed description. Examples of materials that may be suitable in some applications include zirconium dioxide (ZrO2), tantalum pentoxide (Ta2O5), niobium pentoxide (Nb2O5), zinc sulfide (ZnS), or titanium dioxide (TiO2).

Referring to FIGS. 1-5, an optical device 100 for viewing a scene or subject and digitally recording images corresponding to the scene or subject being viewed is shown in the figures and described in the detailed description. In embodiments, the device 100 comprises a housing 102 supporting an eyepiece 104, an objective optic 108 and a prism assembly 112 disposed along an optical path PA between the objective optic 108 and the eyepiece 104. In embodiments, the prism assembly 112 comprises a first prism 114 and a second prism 116. In embodiments, the first prism 114 comprises a prism body 138, the prism body 138 comprising a first base 140, a second base 142, and a plurality of faces extending between the first base 140 and the second base 142, the plurality of faces comprising an entrance face 120, an exit face 124, and the intermediate face 122. In embodiments, the prism assembly 112 further comprises a partially-reflective layer 118 disposed on the intermediate face 122 of the first prism 114.

In embodiments, the exit face 124 of the first prism 114 extends between the entrance face 120 and the intermediate face 122 of the first prism 114. In embodiments, the entrance face 120 of the first prism 114 extends between the exit face 124 and the intermediate face 122 of the first prism 114. In embodiments, the intermediate face 122 of the first prism 114 extends between the entrance face 120 and the exit face 124 of the first prism 114. In embodiments, the eyepiece 104 comprises at least one eyepiece lens 106 and the objective optic 108 comprises at least one objective lens 110.

In embodiments, the first prism 114 is positioned such that the light travelling along the optical path PA passes through the entrance face 120 and into the prism body 138. In embodiments, the first prism 114 is configured such that light travelling along the optical path PA is reflected off of the exit face 124 after passing through the entrance face 120 and is configured such that the light travelling along the optical path PA reaches the intermediate face 122 after being reflected off of the exit face 124. In embodiments, the partially-reflective layer 118 is configured such that a first light portion of the light traveling along the optical path PA is transmitted through the partially-reflective layer 118 and a second light portion of the light traveling along the optical path PA is reflected by the partially-reflective layer 118. In embodiments, the first prism 114 is configured such that the second light portion travels through the exit face 124 after being reflected by the partially-reflective layer 118.

In embodiments, the partially-reflective layer 118 comprises a plurality of sublayers. Partially-reflective layer 118 may comprise various materials without deviating from the spirit and scope of the detailed description. Partially-reflective layers that may be suitable in some applications are disclosed in the following United States patents, all of which are hereby incorporated by reference herein in their entireties: U.S. Pat. No. 5,400,179; U.S. Pat. No. 6,654,178; U.S. Pat. No. 7,256,940; U.S. Pat. No. 8,625,201; and U.S. Pat. No. 9,488,766.

Dashed lines are used to illustrate light travelling along an optical path PB through a prism assembly 112 in FIG. 5A through FIG. 5C. FIG. 5A through FIG. 5C may be collectively referred to as FIG. 5. In FIG. 5, dashed lines are used to illustrate light travelling along an optical path PB through the prism assembly 112. As shown in FIG. 5, light travelling along the optical path PB passes through the entrance face 120 of the first prism 114 and into the prism body 138 of the first prism 114. The light travelling along the optical path PB is reflected off of the exit face 124 of the first prism 114 after passing through the entrance face 120. The light travelling along the optical path PB reaches the intermediate face 122 of the first prism 114 after being reflected off of the exit face 124.

In the embodiment of FIG. 5, the prism assembly 112 includes a partially-reflective layer 118 disposed on the intermediate face 122 of the first prism 114. In the embodiment of FIG. 5, the partially-reflective layer 118 is configured such that a first light portion of the light traveling along the optical path PB is transmitted through the partially-reflective layer 118 and a second light portion of the light traveling along the optical path PB is reflected by the partially-reflective layer 118. In the embodiment of FIG. 5, the second light portion travels through the exit face 124 of the first prism 114 after being reflected by the partially-reflective layer 118.

In the embodiment of FIG. 5, the second light portion travels through the input face 130 of the second prism 116 after traveling through the exit face 124 of the first prism 114. The second light portion is reflected off of the output face 132 of the second prism 116 after the second light portion travels through the input face 130 of the second prism 116 in the embodiment of FIG. 5. The second light portion is reflected off of the first face 134 of the second prism 116 after the second light portion is reflected off of the output face 132 of the second prism 116. The second light portion is reflected off of the second facet 136 of the second prism 116 after the second light portion is reflected off of the first facet 134 of the second prism 116. The second light portion is reflected off of the input face 130 of the second prism 116 after the second light portion is reflected off of the second facet 136 of the second prism 116. The second light portion travels through the output face 132 of the second prism 116 after being reflected off of the input face 130 of the second prism 116.

In embodiments, the second prism 116 comprises a prism body 144, the prism body 144 comprising a first base 146, a second base 148, and a plurality of faces extending between the first base 146 and the second base 148. In embodiments, the plurality of faces comprises an input face 130 and an output face 132. In embodiments, the second prism 116 further comprises a first facet 134 and a second facet 136 that meet at an apex 194. In embodiments, the first facet 134 extends in a first direction between the first base 140 and the apex 194, and the first facet extends in a second direction between the input face 130 and the output face 132. In embodiments, the second facet 136 extends in a first direction between the second base 148 and the apex 194 and the second facet extends in a second direction between the input face 130 and the output face 132. In embodiments, the first prism 114 comprises a half-penta prism and second prism comprises Schmidt roof prism. In embodiments, the prism assembly 112 comprises a Schmidt-Pechan prism.

In embodiments, the first prism 114 and the second prism 116 are positioned so that the second light portion travels through the input face 130 of the second prism 116 after traveling through the exit face 124 of the first prism 114. In embodiments, the second prism 116 is configured so that the second light portion is reflected off of the output face 132 of the second prism 116 after the second light portion travels through the input face 130 of the second prism 116. In embodiments, the second prism 116 is configured so that the second light portion is reflected off of the first facet 134 of the second prism 116 after the second light portion is reflected off of the output face 132 of the second prism 116. In embodiments, second prism 116 is configured so that the second light portion is reflected off of the second facet 136 of the second prism 116 after the second light portion is reflected off of the first facet 134 of the second prism 116. In embodiments, the second prism 116 is configured so that the second light portion is reflected off of the input face 130 of the second prism 116 after the second light portion is reflected off of the second facet 136 of the second prism 116. In embodiments, the second prism 116 is configured such that the second light portion travels through the output face 132 of the second prism 116 after being reflected off of the input face 130 of the second prism 116.

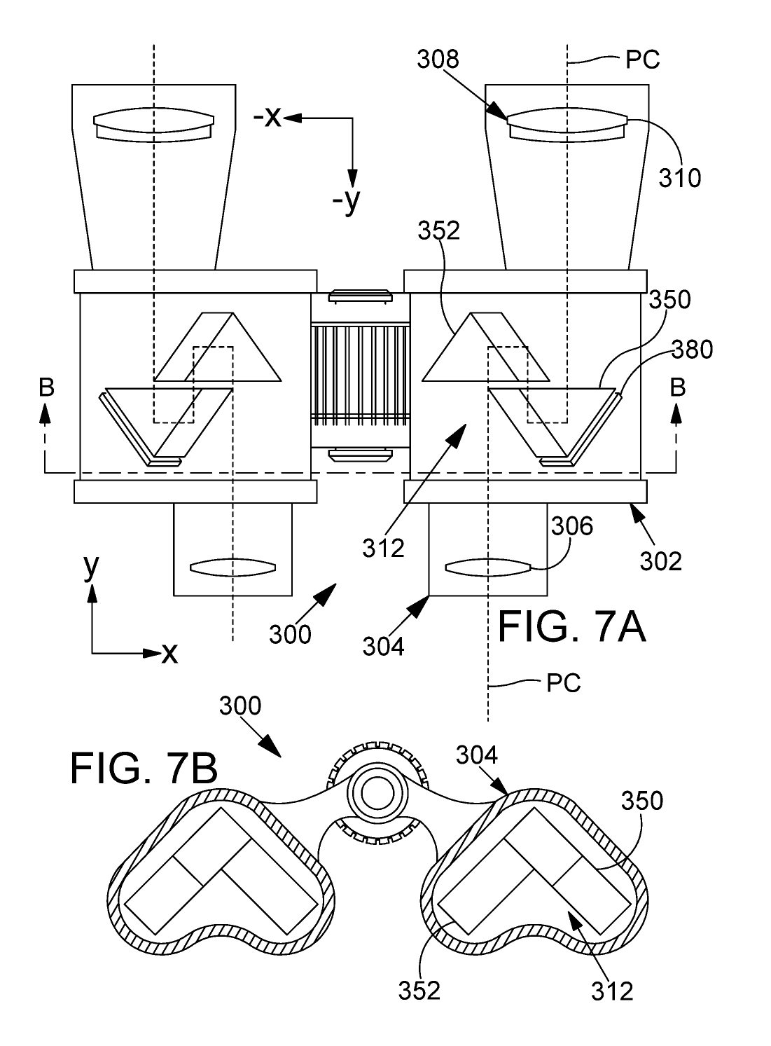

FIGS. 7A to FIG. 7B depict an embodiment of a compact optical device that includes a beam-splitting prism system that utilizes a pair of Porro prisms and a partially-reflective plate adjacent to the prisms.

FIG. 7A is a stylized plan view showing an optical device 300 for viewing a scene or subject and digitally recording images corresponding to the scene or subject being viewed. Optical devices in accordance with the detailed description may include, by way of example and not limitation, binoculars, monoculars, spotting scopes, telescopes, and the like. In the example embodiment of FIG. 7, the optical device 300 comprises a binocular device. FIG. 7B is a cross-sectional view showing the optical device 300 sectioned along line B-B shown in FIG. 7A. FIG. 7A and FIG. 7B may be collectively referred to as FIG. 7.

The optical device 300 of FIG. 7 comprises a housing 302 supporting a first eyepiece 304A, a first objective optic 308A and a first prism assembly 312A disposed along an optical path PA between the first objective optic 308A and the first eyepiece 304A. As shown in FIG. 7, the housing 302 also supports a second eyepiece 304B, a second objective optic 308B and a second prism assembly 312B disposed along an optical path PB between the second objective optic 308B and the second eyepiece 304B. In the embodiment of FIG. 7, each eyepiece includes an eyepiece lens 306 and each objective optic includes an objective lens 310. Each prism assembly includes a first prism 350 and a second prism 352. In an embodiment, both the first prism assembly 312A and the second prism assembly 312B comprise beam-splitting prism assemblies. In another embodiment, only one of the first prism assembly 312A and the second prism assembly 312B comprise a beam-splitting prism assembly. In one such embodiment, the non-beam splitting assembly comprises a standard, known prism assembly.

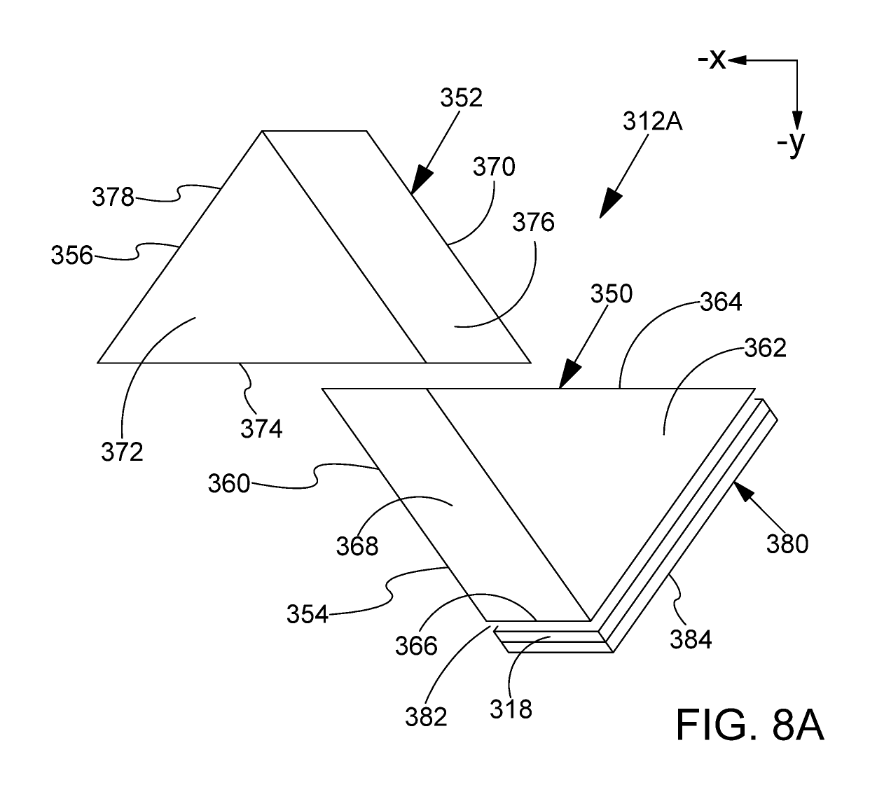

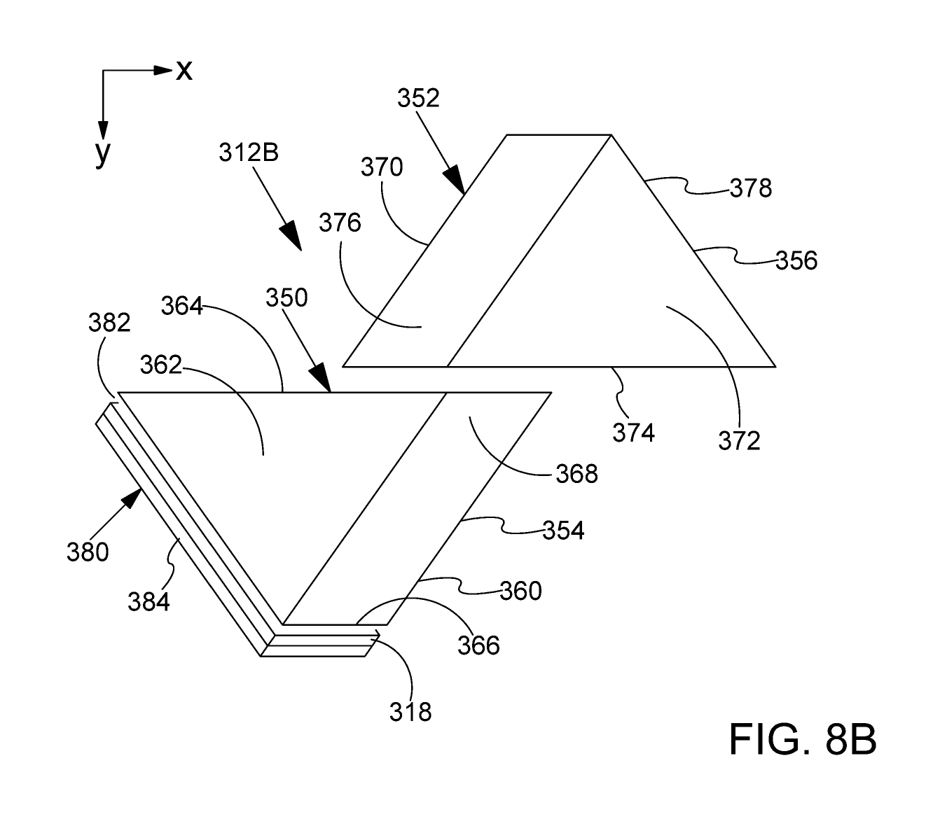

FIG. 8A is an enlarged plan view further illustrating the first prism assembly 312A of the optical device 300 shown in FIG. 7. FIG. 8B is an enlarged plan view further illustrating the second prism assembly 312B of the optical device 300 shown in FIG. 7. FIG. 8A and FIG. 8B may be collectively referred to as FIG. 8. With reference to FIG. 8 it will be appreciated that each prism assembly comprises a first prism 350 and a second prism 352. The first prism 350 and the second prism 352 each comprise a Porro prism in the example embodiment of FIG. 8.

In the embodiment of FIG. 8, the first prism 350 comprises a prism body 354. With reference to FIG. 8, it will be appreciated that the prism body 354 comprises a first base 360, a second base 362, and a plurality of faces extending between the first base 360 and the second base 362. In the embodiment of FIG. 8, the plurality of faces include an entrance face 364, a first side face 366, and a second side face 368. The second prism 352 comprises a prism body 356 in the embodiment of FIG. 8. As shown in FIG. 8, the prism body 356 has a first base 370, a second base 372, and a plurality of faces extending between the first base 370 and the second base 372. The plurality of faces include an exit face 374, a third side face 376, and a fourth side face 378 in the embodiment of FIG. 8.

In the embodiment of FIG. 8, a plate 380 is located in close proximity to the first side face 366 of the first prism 350. In embodiments, locating a plate in close proximity to one side face of a prism provides an arrangement that takes advantage of a phenomenon known as frustrated total internal reflection (FTIR). The plate 380 comprises a plate body 384 and a partially-reflective layer 318 overlaying one face of the plate body 384. In an embodiment, the plate body 384 comprises glass, metal, or another appropriate material. The plate 380 and the first prism 350 are positioned so that a gap 382 is defined between the partially-reflective layer 318 and the first side face 366.

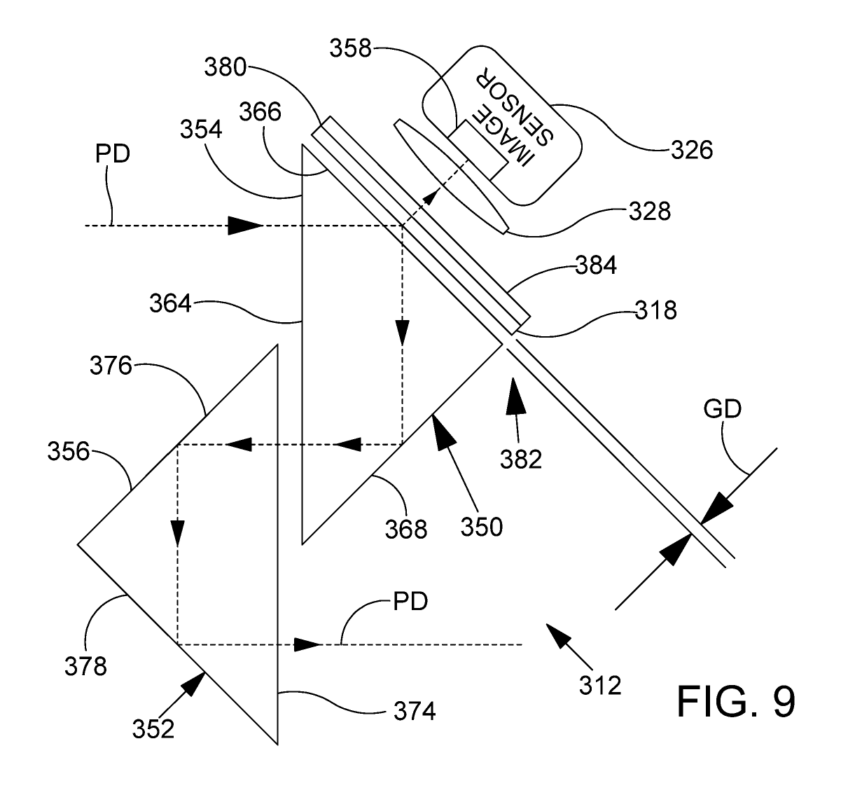

FIG. 9 is a diagrammatic plan view showing an example prism assembly 312. The prism assembly 312 of FIG. 9 includes a first prism 350 and a second prism 352. In the example embodiment of FIG. 9, the first prism 350 and the second prism 352 each comprise a Porro prism. In the embodiment of FIG. 9, the first prism 350 comprises a prism body 354 having a plurality of faces. In the embodiment of FIG. 9, the plurality of faces of the prism body 354 comprise an entrance face 364, a first side face 366, and a second side face 368. The second prism 352 comprises a prism body 356 having a plurality of faces in the embodiment of FIG. 9. As shown in FIG. 9, the prism body 356 of the second prism 352 comprises an exit face 374, a third side face 376, and a fourth side face 378.

Incident light traveling along an optical path PD is shown using dashed lines in FIG. 9. The light travelling along the optical path PD passes through the entrance face 364 of the first prism 350 and into the first prism body 354. In embodiments, light travelling along the optical path PD is reflected off of the first side face 366 of the first prism 350 via total internal reflection after passing through the entrance face 364 of the first prism 350. In the embodiment of FIG. 9, however, the presence of a plate 380 in close proximity to the first side face 366 of the first prism 350 produces frustrated total internal reflection (FTIR). Due to FTIR, the light travelling along the optical path PD passes through the first side face 366 of the first prism 350 strikes the plate 380.

The plate 380 comprises a plate body 384 and a partially-reflective layer 318 overlaying one face of the plate body 384. In the example embodiment of FIG. 9, the partially-reflective layer 318 is configured so that a first light portion of the light traveling along the optical path is transmitted through the partially-reflective layer 318 and a second light portion of the light traveling along the optical path is reflected by the partially-reflective layer 318.

An image sensor 326 and a sensor optical system 328 are also visible in FIG. 9. In the embodiment of FIG. 9, the image sensor 326 is located near the first side face 366 of the first prism 350 with the plate 380 disposed between the image sensor 326 and the first side face 366 of the first prism 350. In FIG. 9, the sensor optical system 328 can be seen positioned between the plate 380 and the image sensor 326. The sensor optical system 328 may receive light passing through the plate 380 and form an image on a sensor portion 358 of the image sensor 326. The plate 380 and the first prism 350 are positioned so that a gap 382 is defined between the partially-reflective layer 318 and the first side face 366. The gap 382 has a width GD that is illustrated using dimension lines in FIG. 9.

In the embodiment of FIG. 9, light travelling along the optical path PD is reflected off of the second side face 368 of the first prism 350 after being reflected off of the partially-reflective layer 318. In FIG. 9, the light travelling along the optical path PD is shown passing through the entrance face 364 of the first prism 350 after being reflected off of the second side face 368 of the first prism 350. The light travelling along the optical path PD passes through the exit face 374 of the second prism after passing through the entrance face 364 of the first prism 350. The light travelling along the optical path PD is reflected off of the first side face 376 of the second prism 352 after passing through the exit face 374 of the second prism 352. The light travelling along the optical path PD is reflected off of the second side face 378 of the second prism 352 after being reflected off of the first side face 376 of the second prism 352. The light travelling along the optical path PD passes through the exit face 374 of the second prism 352 after being reflected off of the second side face 378 of the second prism 352.

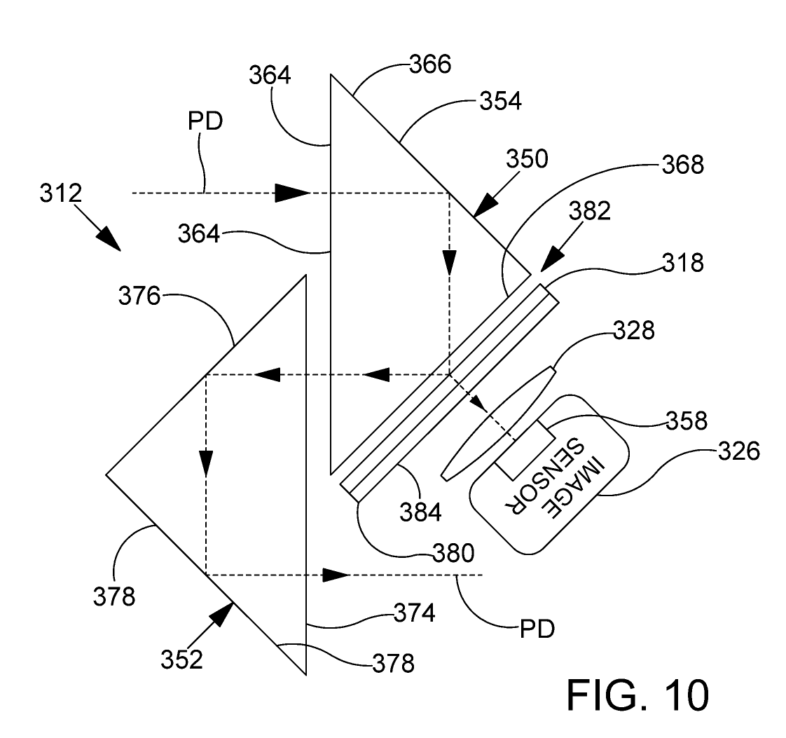

FIGS. 10, 11, and 12 are diagrammatic plan views showing additional example embodiments of prism assemblies 312. Each example prism assembly 312 includes a first prism 350 and a second prism 352. Incident light traveling along an optical path PD through the first prism 350 and the second prism 352 is shown using a dashed line in FIGS. 10, 11, and 12.

In the embodiment of FIG. 10, the light travelling along the optical path PD passes through the entrance face 364 of the first prism 350 and into the first prism body 354. In the embodiment of FIG. 10, the light travelling along the optical path PD is reflected off of the first side face 366 of the first prism 350 via total internal reflection after passing through the entrance face 364 of the first prism 350. In embodiments, light travelling along the optical path PD is reflected off of the second side face 368 of the first prism 350 after being reflected off of first side face 366 of the first prism 350. In the embodiment of FIG. 10, however, the presence of a plate 380 in close proximity to the second side face 368 of the first prism 350 produces frustrated total internal reflection (FTIR). Due to FTIR, the light travelling along the optical path PD passes through the second side face 368 of the first prism 350 and strikes a partially-reflective layer 318 of the plate 380. In the example embodiment of FIG. 10, the partially-reflective layer 318 is configured so that a first light portion of the light traveling along the optical path is transmitted through the partially-reflective layer 318 and a second light portion of the light traveling along the optical path is reflected by the partially-reflective layer 318.

An image sensor 326 and a sensor optical system 328 are also visible in FIG. 10. The image sensor 326 may comprise various image sensing devices without deviating from the spirit and scope of the detailed description. Image sensing devices that may be suitable in some applications are disclosed in the following United States patents, all of which are hereby incorporated by reference herein: U.S. Pat. No. 4,805,026, U.S. Pat. No. 4,816,916, U.S. Pat. No. 5,111,263, U.S. Pat. No. 3,106,429, U.S. Pat. No. 6,160,282, U.S. Pat. No. 6,177,293, U.S. Pat. No. 6,635,912, U.S. Pat. No. 7,153,720, U.S. Pat. No. 7,294,873, U.S. Pat. No. 9,437,644, U.S. Pat. No. 9,590,652, and U.S. Pat. No. 9,615,042.

In the embodiment of FIG. 10, the image sensor 326 is located near the second side face 368 of the first prism 350 with the plate 380 disposed between the image sensor 326 and the second side face 368 of the first prism 350. In FIG. 10, a sensor optical system 328 can be seen positioned between the plate 380 and the image sensor 326. The sensor optical system 328 may receive light passing through the plate 380 and form an image on a sensor portion 358 of the image sensor 326. The plate 380 and the first prism 350 are positioned so that a gap 382 is defined between the partially-reflective layer 318 and the second side face 368.

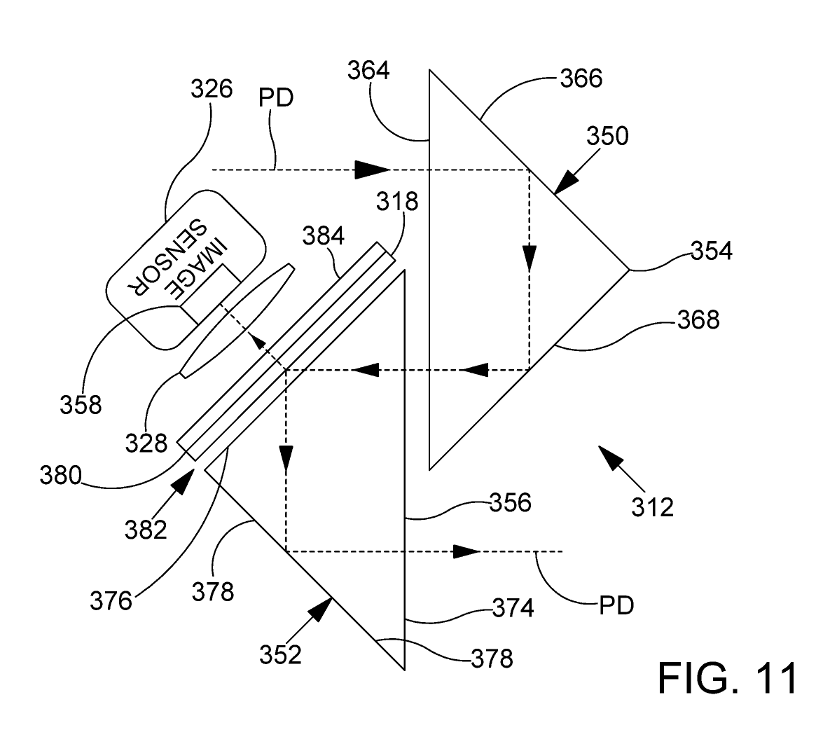

In the embodiment of FIG. 11, the light travelling along the optical path PD passes through the exit face 374 of the second prism 352 and into the second prism body 356. In embodiments, light travelling along the optical path PD is reflected off of the third side face 376 of the second prism 352 after passing into the second prism body 356 via the exit face 374. In the embodiment of FIG. 11, however, the presence of a plate 380 in close proximity to the third side face 376 of the second prism 352 produces frustrated total internal reflection (FTIR). Due to FTIR, the light travelling along the optical path PD passes through the third side face 376 of the second prism 352 and strikes a partially-reflective layer 318 of the plate 380. In the example embodiment of FIG. 11, the partially-reflective layer 318 is configured so that a first light portion of the light traveling along the optical path is transmitted through the partially-reflective layer 318 and a second light portion of the light traveling along the optical path is reflected by the partially-reflective layer 318. Light transmitted through the plate 380 may be received by a sensor optical system 328. The sensor optical system 328 may form an image on a sensor portion 358 of an image sensor 326.

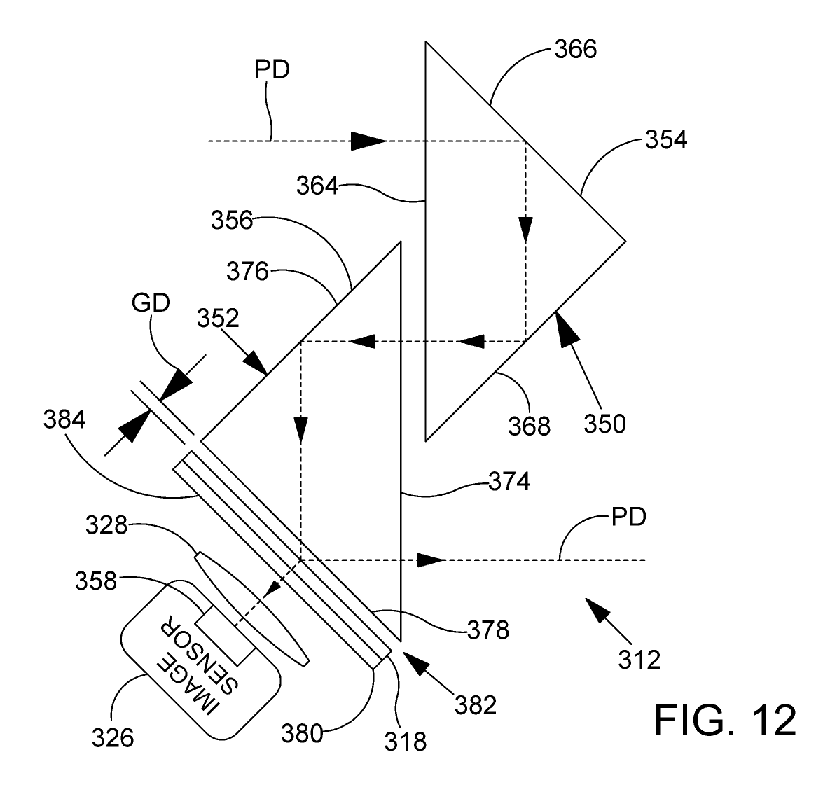

In the embodiment of FIG. 12, the light travelling along the optical path PD passes through the exit face 374 of the second prism 352 and into the second prism body 356. In the embodiment of FIG. 12, the light travelling along the optical path PD is reflected off of the third side face 376 of the second prism 352 via total internal reflection after passing through the exit face 374 of the second prism 352. In embodiments, light travelling along the optical path PD is reflected off of the fourth side face 378 of the second prism 352 after being reflected off of third side face 376 of the second prism 352. In the embodiment of FIG. 12, however, the presence of a plate 380 in close proximity to the fourth side face 378 of the second prism 352 produces frustrated total internal reflection (FTIR). Due to FTIR, the light travelling along the optical path PD passes through the fourth side face 378 of the second prism 352 and strikes a partially-reflective layer 318 of the plate 380. In the example embodiment of FIG. 12, the partially-reflective layer 318 is configured so that a first light portion of the light traveling along the optical path is transmitted through the partially-reflective layer 318 and a second light portion of the light traveling along the optical path is reflected by the partially-reflective layer 318. Light transmitted through the plate 380 may be received by a sensor optical system 328. The sensor optical system 328 may form an image on a sensor portion 358 of an image sensor 326.

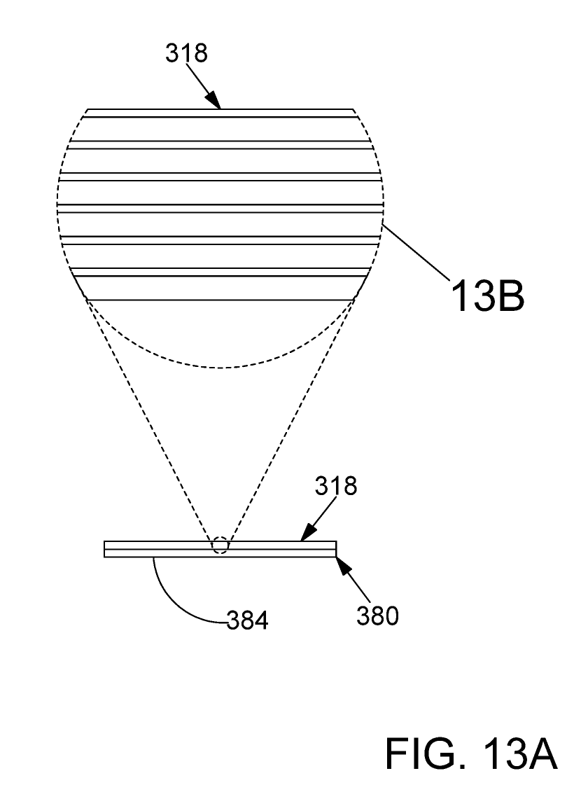

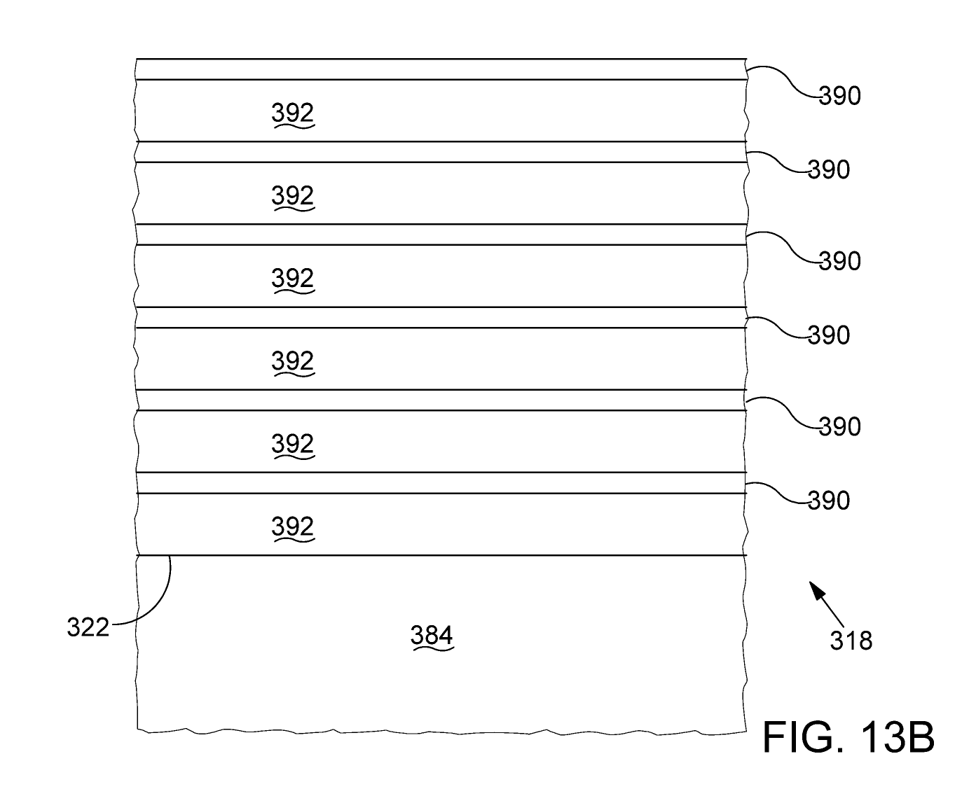

FIG. 13A is an elevation view showing an example plate 380. The plate 380 of FIG. 13A comprises a plate body 384 and a partially-reflective layer 318 overlaying one face of the plate body 384. FIG. 13B is an enlarged section view further illustrating the partially-reflective layer 318 shown in FIG. 13A. FIG. 13A and FIG. 13B may be collectively referred to as FIG. 13.

In an embodiment, partially-reflective layer 318 comprises a single layer without sublayers. However, in the embodiment of FIG. 13, the partially-reflective layer 318 comprises a plurality of more refractive sublayers 390 and a plurality of less refractive sublayers 392. Also in the embodiment of FIG. 13, the more refractive sublayers 390 and the less refractive sublayers 392 are arranged in an alternating pattern with one of the more refractive sublayers 390 overlaying each of the less refractive sublayers 392. In the embodiment of FIG. 13, the partially-reflective layer 318 is disposed over one face of the plate body 384. In some useful embodiments, each of the less refractive sublayers 392 has a first refractive index in a first range and each of the more refractive sublayers 390 has a second refractive index in a second range. In embodiments, the first range is from about 1.0 to about 1.91 and the second range is from about 1.92 to about 2.9. In embodiments, the first range is from about 1.2 to about 1.9 and the second range is from about 2.0 to about 2.8.

Each of the less refractive sublayers 392 may comprise various materials without deviating from the spirit and scope of this detailed description. Examples of materials that may be suitable in some applications include magnesium fluoride (MgF2), silicon dioxide (SiO2), and aluminum oxide (Al2O3).

Each of the more refractive sublayers 390 may comprise various materials without deviating from the spirit and scope of this detailed description. Examples of materials that may be suitable in some applications include zirconium dioxide (ZrO2), tantalum pentoxide (Ta2O5), niobium pentoxide (Nb2O5), zinc sulfide (ZnS), or titanium dioxide (TiO2).

In an embodiment, the number of sublayers 390 is equal to the number of sublayers 392, as depicted, such that the ratio of sublayers 390 to sublayers 392 is 1:1. In embodiment, partially-reflective layer 318 comprises a singly refractive sublayer 390 and a single refractive sublayer 392. In an embodiment, partially-reflective layer 318 comprises a plurality of more refractive sublayers 390 and a plurality of less refractive sublayers 392. In an embodiment, the plurality of each sublayer 390 and 392 comprises 2-6 sublayers. In an embodiment, the plurality of each sublayer 390 and 392 comprises more than 6 sublayers.

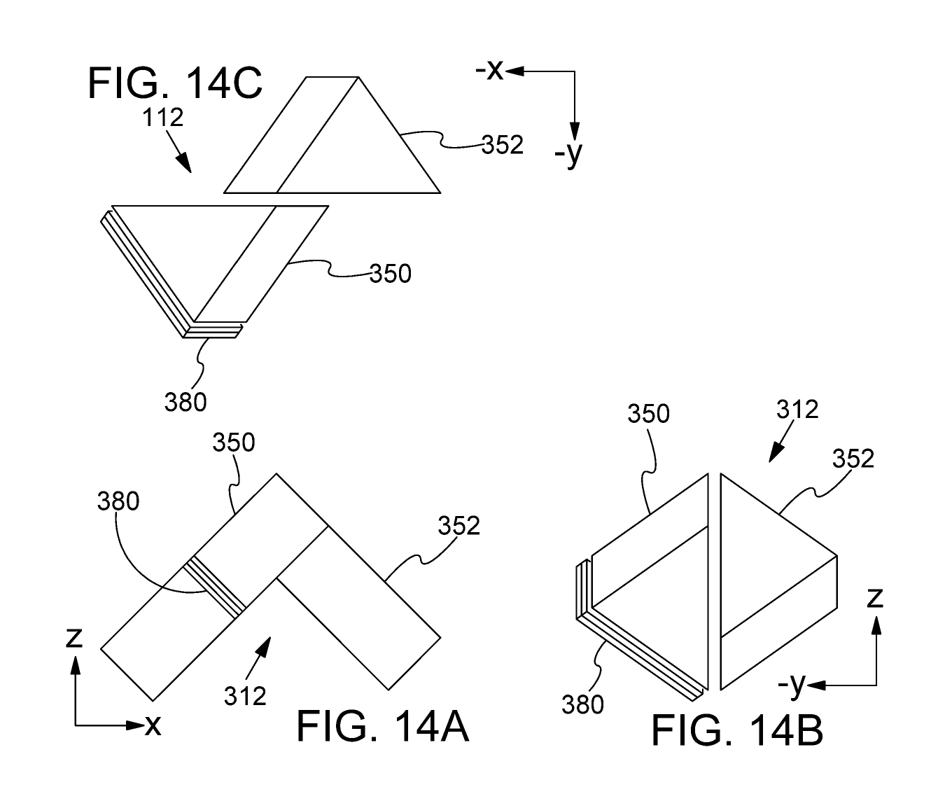

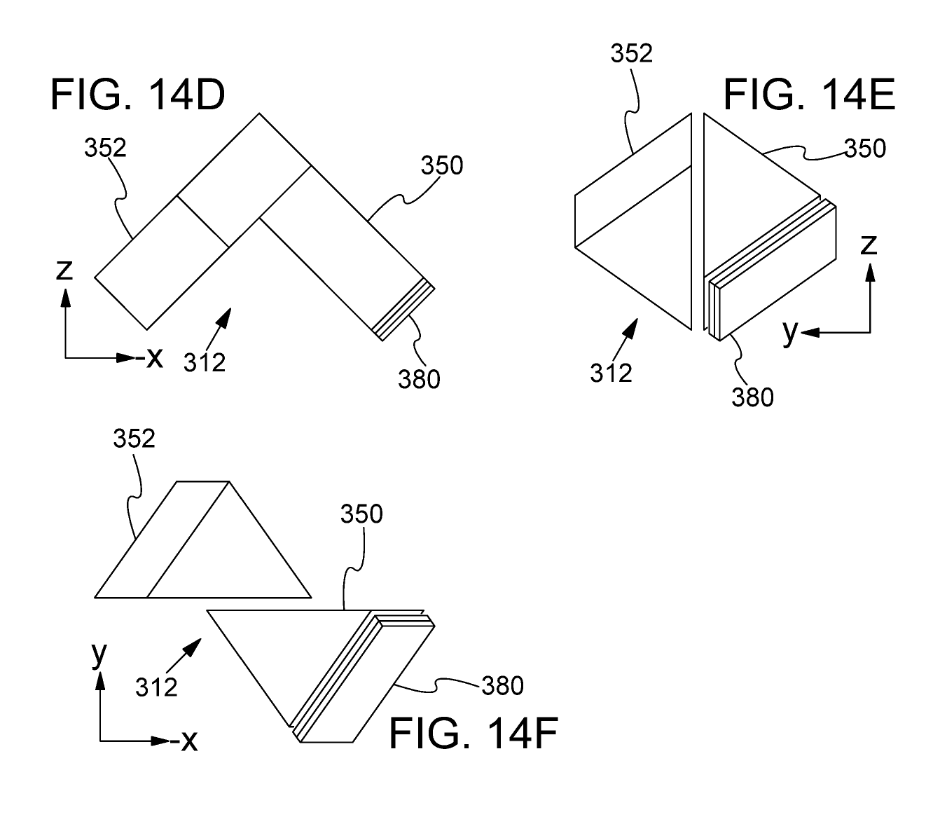

FIG. 14A through FIG. 14F are elevation and plan views showing six sides of a prism assembly 312 including a first prism 350 and a second prism 352. A person of ordinary skill in the art would generally refer to the process used to create views showing six sides of a three dimensional object as a multi-view projection or orthographic projection. It is customary to refer to multi-view projections using terms such as front view, right side view, top view, rear view, left side view, and bottom view. Accordingly, terms such as front view and right side view may be used as a convenient method for discussing the views shown in FIG. 14. It will be appreciated that the elements shown in FIG. 14 may assume various orientations without deviating from the spirit and scope of this detailed description. Accordingly, the terms front view, right side view, top view, rear view, left side view, bottom view, and the like should not be interpreted to limit the scope of the invention recited in the attached claims. FIG. 14A through FIG. 14F may be collectively referred to as FIG. 14. In the embodiment of FIG. 14, a plate 380 is located in close proximity to one side face of the first prism 350. In embodiments, locating a plate in close proximity to one side face of a prism provides an arrangement that takes advantage of a phenomenon known as frustrated total internal reflection (FTIR).

Referring to FIGS. 1, 2, 4, 7, 8, and 14, forward, rearward, starboard, and port directions are illustrated using arrows. These directions may be conceptualized from the point of view of a person viewing a scene or subject through binoculars, such as, for example, the binoculars shown in FIG. 1 and/or the binoculars shown in FIG. 7. The forward direction Y and the rearward direction −Y are illustrated using arrows labeled “Y” and “−Y,” respectively. The starboard direction X and the port direction −X are illustrated using arrows labeled “X” and “−X,” respectively. The upward direction Z and the downward or lower direction −Z are illustrated using arrows labeled “Z” and “−Z,” respectively, in FIG. 8. The directions illustrated using these arrows are applicable to the apparatus throughout this application. The port direction may also be referred to as the portward direction. In embodiments, the upward direction is generally opposite the downward direction. In embodiments, the upward direction and the downward direction are both generally orthogonal to an XY plane defined by the forward direction and the starboard direction. In embodiments, the forward direction is generally opposite the rearward direction. In embodiments, the forward direction and the rearward direction are both generally orthogonal to a

ZY plane defined by the upward direction and the starboard direction. In embodiments, the starboard direction is generally opposite the port direction. In embodiments, starboard direction and the port direction are both generally orthogonal to a ZX plane defined by the upward direction and the forward direction. Various direction-indicating terms are used herein as a convenient way to discuss the objects shown in the figures. It will be appreciated that many direction indicating terms are related to the instant orientation of the object being described. It will also be appreciated that the objects described herein may assume various orientations without deviating from the spirit and scope of this detailed description. Accordingly, direction-indicating terms such as “upwardly,” “downwardly,” “forwardly,” “backwardly,” “portwardly,” and “starboard,” should not be interpreted to limit the scope of the invention recited in the attached claims.

The following United States patents are hereby incorporated by reference herein: U.S. Pat. No. 5,963,369, U.S. Pat. No. 6,487,012, U.S. Pat. No. 6,927,906, U.S. Pat. No. 6,937,391, and U.S. Pat. No. 7,961,387. The above references to U.S. patents in all sections of this application are herein incorporated by references in their entirety for all purposes. Components illustrated in such patents may be utilized with embodiments herein. Incorporation by reference is discussed, for example, in MPEP section 2163.07(B).

The above references in all sections of this application are herein incorporated by references in their entirety for all purposes. All of the features disclosed in this specification (including the references incorporated by reference, including any accompanying claims, abstract and drawings), and/or all of the steps of any method or process so disclosed, may be combined in any combination, except combinations where at least some of such features and/or steps are mutually exclusive.

Each feature disclosed in this specification (including references incorporated by reference, any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any incorporated by reference references, any accompanying claims, abstract and drawings), or to any novel one, or any novel combination, of the steps of any method or process so disclosed The above references in all sections of this application are herein incorporated by references in their entirety for all purposes.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative aspects. The above described aspects embodiments of the invention are merely descriptive of its principles and are not to be considered limiting. Further modifications of the invention herein disclosed will occur to those skilled in the respective arts and all such modifications are deemed to be within the scope of the invention.

What is claimed is:

1. A compact optical device for viewing a scene or subject and digitally recording images corresponding to the scene or subject being viewed, the device comprising:
a housing supporting an eyepiece and an objective optic, the eyepiece comprising at least one eyepiece lens, and the objective optic comprising at least one objective lens;
a prism assembly disposed along an optical path between the objective optic and the eyepiece, the prism assembly comprising a first prism and a second prism;
the first prism comprising a prism body, the prism body comprising a first base, a second base, and a plurality of faces extending between the first base and the second base, the plurality of faces comprising an entrance face, a first side face, and a second side face;
the second prism comprising a prism body, the prism body comprising a first base, a second base, and a plurality of faces extending between the first base and the second base, the plurality of faces comprising a third side face, a fourth side face, and an exit face;
a plate positioned adjacent to a selected face of the prism assembly, the plate comprising a plate body and a partially-reflective coating disposed on one face of the plate body, a gap being defined between the partially-reflective coating and the selected face of the prism assembly, the selected face being one of the first side face, the second side face, the third side face and the forth side face;
a sensor optical system configured to receive light transmitted through the plate and form an image based on the received light.

2. The device of claim 1, wherein the gap defined between the partially-reflective coating and the selected face of the prism assembly has a width between 50 nm and 5000 nm.

3. The device of claim 1, wherein the partially-reflective layer comprises a first plurality of refractive sublayers having a first refractive index and a second plurality of refractive sublayers having a second refractive index, the first refractive index being greater than the second refractive index.

4. The device of claim 3, wherein the first plurality of sublayers and the second plurality of sublayers are arranged in an alternating pattern with each one of the first plurality of sublayers overlaying one of the second refractive sublayers.

5. The device of claim 3, wherein each of the second plurality of refractive sublayers has a first refractive index in a first range, and each of the first plurality of refractive sublayers has a second refractive index in a second range.

6. The device of claim 5, wherein first range and the second range overlap.

7. The device of claim 5, wherein first range and the second range do not overlap.

8. The device of claim 5, wherein the second range is from about 1.0 to about 1.91 and the first range is from about 1.92 to about 2.9.

9. The device of claim 3, wherein at least one of the first plurality of refractive sublayers is disposed between two of the second plurality of refractive sublayers.

10. The device of claim 1, wherein the first prism comprises a Porro prism and the second prism comprises a Porro prism.

11. A compact optical device for viewing a scene or subject and digitally recording images corresponding to the scene or subject being viewed, the device comprising:
a housing supporting an eyepiece and an objective optic, the eyepiece comprising at least one eyepiece lens, and the objective optic comprising at least one objective lens;
a prism assembly disposed along an optical path between the objective optic and the eyepiece, the prism assembly comprising a Schmidt roof prism, a half-penta prism and a partially-reflective layer disposed on a face of the half-penta prism, the partially-reflective layer being configured such that a first light portion of light traveling along the optical path is transmitted through the partially-reflective layer and a second light portion of the light traveling along the optical path is reflected by the partially-reflective layer, the second light portion comprising light of visible wavelengths that are substantially the same as those of the first light portion;
a sensor optical system configured to receive the first light portion and form an image based on the first light portion.

12. The device of claim 11, wherein the partially-reflective layer has reflectivity of 80% for light having wavelengths between 400 nm and 700 nm.

13. The device of claim 11, wherein the partially-reflective layer comprises a first plurality of refractive sublayers having a first refractive index and a second plurality of refractive sublayers having a second refractive index, the first refractive index being greater than the second refractive index.

14. The device of claim 13, wherein the first plurality of sublayers and the second plurality of sublayers are arranged in an alternating pattern with each one of the first plurality of sublayers overlaying one of the second refractive sublayers.

15. The device of claim 13, each of the second plurality of refractive sublayers has a first refractive index in a first range, and each of the first plurality of refractive sublayers has a second refractive index in a second range.

16. The device of claim 13, wherein first range and the second range overlap.

17. The device of claim 13, wherein first range and the second range do not overlap.

18. The device of claim 13, wherein the second range is from about 1.0 to about 1.91 and the first range is from about 1.92 to about 2.9.

19. The device of claim 13, wherein the second range is from about 1.2 to about 1.9 and the first range is from about 2.0 to about 2.8.

20. The device of claim 13, wherein each of the second refractive sublayers is disposed between two of the plurality of first refractive sublayers.
